(19) United States
(12) Patent Application Publication
(10) Pub. No.: US 2004/0010725 A1
(43) Pub. Date: Jan. 15, 2004

(54) Embedded interruptible power supply

(75) Inventor: Johni Chan, Rancho Santa Fe, CA (US)

Correspondence Address: FITCH EVEN TABIN AND FLANNERY, 120 SOUTH LA SALLE STREET, SUITE 1600, CHICAGO, IL, 60603-3406, US

(73) Assignee: I-BUS\Phoenix, Incorporated, San Diego, CA

(21) Appl. No.: 10/195,139

(22) Filed: Jul. 11, 2002

(51) Int. Cl. G06F 1/26

(52) U.S. Cl. 713/300

(57) ABSTRACT

An apparatus for powering a computer system comprising a power input line for providing power to the computer system; a hot-swappable management module coupled to the power input line which monitors the power input line for a failure; and a hot-swappable battery coupled to the power input line and the management module which provides power to the computer system upon the failure of the power input line. A method of powering a computer system comprising powering the computer system from a power input line; monitoring the power input line with a management module for a failure of the power input line; powering the computer system from a battery in the event of the failure of the power input line; and replacing the battery and the management module without interrupting the powering of the computer system from the power input line.

### BACKGROUND OF THE INVENTION

1. Field of the Invention

The present invention relates generally to electric power supplies, and more specifically to redundant, backup power supplies. Even more specifically, the present invention relates to hot-swappable power supplies for providing backup power to computer systems.

2. Discussion of the Related Art

For many critical or important electrical and/or electronic equipment or systems, it is desirable to have an alternate, or “standby,” power source if a primary power source is lost or becomes unreliable.

A few examples of such equipment or systems are main frame computer systems for, hospital operating rooms and critical care equipment, air traffic control systems, police and fire emergency equipment, telecommunications systems, and national security systems. As may be imagined, the failure of a power supply to deliver a predictable power can have serious and potentially dangerous consequences.

It is, therefore, common to provide standby electrical power supplies to provide redundant power to a secondary power supply. Commonly, the primary power is supplied by a local utility company at, e.g., 240 volts AC or 120 volts AC at 60 Hertz.

Many types of standby power sources are available, including turbines, micro-turbines, battery powered inverters, rotary engines, internal combustion engines, and more and more recently, high-speed electrical generators and flywheels have been developed. These standby power sources may vary from the primary power in terms of voltage, phase and frequency. Thus, the primary and standby power supplies may be unsynchronized, and if the primary and secondary supplies are applied to a load simultaneously, potentially harmful voltage spikes and current surges may occur.

A traditional Uninterruptible Power Supply (UPS) is plugged into the AC outlet and then the computer system is connected in series with the UPS. Systems which utilize a battery powered standby power source are configured so as to allow the backup battery to be replaced while the computer system is on. However, upon a failure of the UPS, the system must be powered down. Thus it would be advantageous to provide a system where the UPS could be replaced without powering down the computer system.

### SUMMARY OF THE INVENTION

The present invention advantageously addresses the needs above as well as other needs by providing an uninterruptible power supply (UPS) that can be replaced or upgraded without powering down equipment for which the UPS provides a standby power source. Additionally, the present invention, in one embodiment, provides switching means on the rectified outputs of power supply inputs to isolate the inputs from mutual electrical interaction. Advantageously, the present invention, in other embodiments, also provides an embedded UPS for the equipment that provides standby (or backup) power to the computer system without taking up external rack space, such as with an external UPS.

In one embodiment, the invention can be characterized as an apparatus for powering a computer system comprising a power input line for providing power to the computer system; a hot-swappable management module coupled to the power input line which monitors the power input line for a failure; and a hot-swappable battery coupled to the power input line and the management module which provides power to the computer system upon the failure of the power input line.

In another embodiment, the invention can be characterized as a method of powering a computer system comprising powering the computer system from a power input line; monitoring the power input line with a management module for a failure of the power input line; powering the computer system from a battery in the event of the failure of the power input line; and replacing the battery and the management module without interrupting the powering of the computer system from the power input line.

In a further embodiment, the invention may be characterized as a method of powering a computer system comprising supplying the computer system with power from a power line; monitoring the power line for a failure with an operational amplifier; receiving a failure signal at a microprocessor upon detection of the failure from the operational amplifier; sending a switching signal from the microprocessor in response to the receiving of the failure signal; supplying the computer system with power from a hot-swappable battery in response to the sending of the switching signal from the microprocessor.

In yet a further embodiment the invention may be characterized as a method of powering a computer system comprising powering the computer system from a power line; monitoring the power line with a first management module for a failure of the power line; replacing the first management module and the first battery with a second management module and a second battery while the computer system is powered on; monitoring the power line with the second management module for the failure of the power line; and powering the computer system with the second battery in the event of a detection of the failure of the power line by the second management module.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a functional block diagram depicting functional elements of an embedded uninterruptible power supply in accordance with one embodiment of the invention;

FIG. 2 is a schematic diagram of a management module shown in FIG. 1;

FIG. 3 is a schematic diagram of a battery charger shown in FIG. 1;

FIG. 4 is a schematic diagram of a boost converter shown in FIG. 1;

FIG. 5 is a schematic diagram of a dual input module; and

FIG. 6 is a backplane diagram of the embedded uninterruptible power supply shown in FIG. 1.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

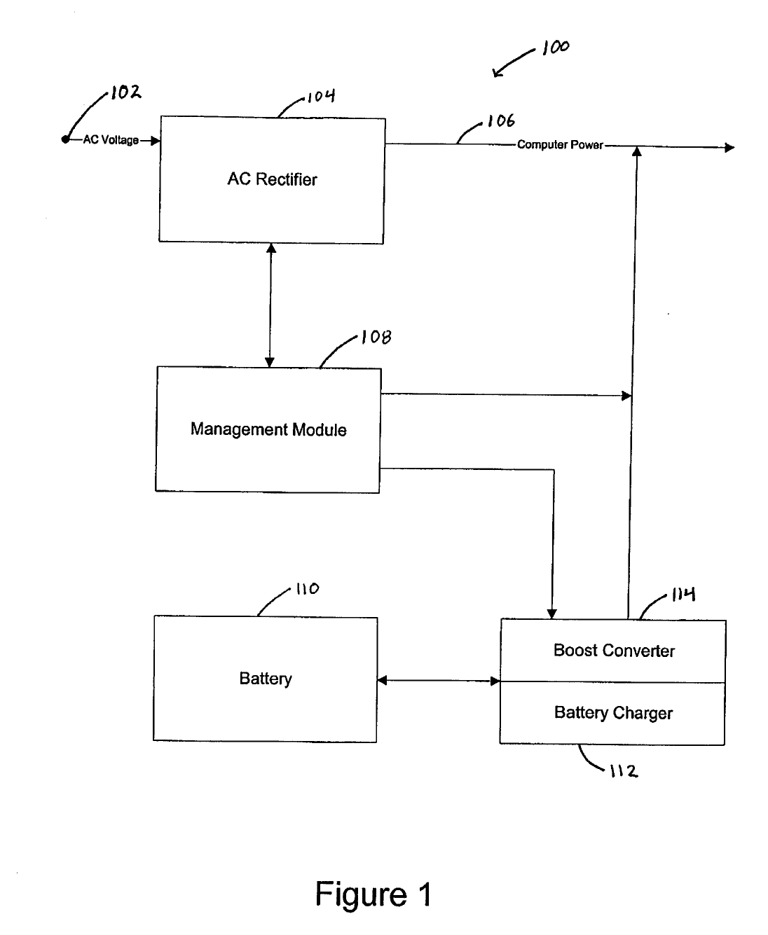

Referring first to FIG. 1, shown is a functional block diagram depicting functional elements of the embedded uninterruptible power supply 100 in accordance with one embodiment of the invention. Shown is a an AC input power line 102, an AC rectifier 104, a computer power line 106 (or other equipment power line 106), a management module 108, a battery 110, a battery charger 112, and a boost converter 114.

In the present embodiment the AC input power line 102 is supplied from a standard power line, e.g., the local utility company. The AC input power line 102 is connected to the AC rectifier 104. The AC rectifier 104 is electrically connected to, for example, a computer power line 106 (or other equipment power line 106) which supplies power to the computer system's (or other equipment power line 106) redundant N+1 secondary power supplies (not shown). The management module 108 is connected to the AC input power line 102. The management module 108 is also coupled to the boost converter 114 and the battery charger 112. The boost converter 114 and the battery charger 112 are also coupled to the computer power line 106. The battery 110 is coupled to the boost converter 114 and the battery charger 112.

During operation, an AC Voltage is input to the AC rectifier 104 through the AC input power line 102. The AC rectified voltage provides power for the redundant secondary power supplies (not shown) which in turn provide the appropriate power levels expected by the computer system (or other equipment). The redundant secondary power supplies are hot-swappable such that there are N+1 secondary power supplies where N is the number of secondary power supplies needed to provide the computer system (or other equipment) with the correct power. If one of the secondary power supplies fails the extra power supply takes over and the failed secondary power supply can be replaced without powering off the computer system (or other equipment).

The management module 108 monitors the AC input power line 102 for a failure. Upon detection of the failure, the management module 108 switches to battery power, such that the redundant secondary power supplies (not shown) are able to operate without interruption. The power from the battery 110 is run through the boost converter 114. In the present embodiment, the boost converter 114 increases the voltage from the battery 110 such that the secondary power supplies receive the correct input voltage. The boost converter 114 is connected to the computer power line 106 and the output from the boost converter 114 supplies the secondary power supplies with the appropriate voltage level.

When the AC voltage is restored at the AC input power line 102 the management module 108 switches the supply power back to the AC input voltage line 102. In a preferred embodiment the battery 110 is coupled to the AC input voltage line 102 through the battery charger 112. This allows for the battery 110 to be charged while the AC input voltage line 102 is supplying power to the secondary power supplies ensuring that the computer system (or other equipment) will have backup power if the AC input voltage line 102 should fail.

The management module 108, the battery 110, the boost converter 114, and the battery charger 112 are all hot-swappable upon the failure of any one of the components. When the AC voltage is being supplied via the AC input power line 102, the management module 108, the battery 110, the boost converter 114 and the battery charger 112 all can be replaced, removed, or upgraded without having the power to the computer system (or other equipment) interrupted.

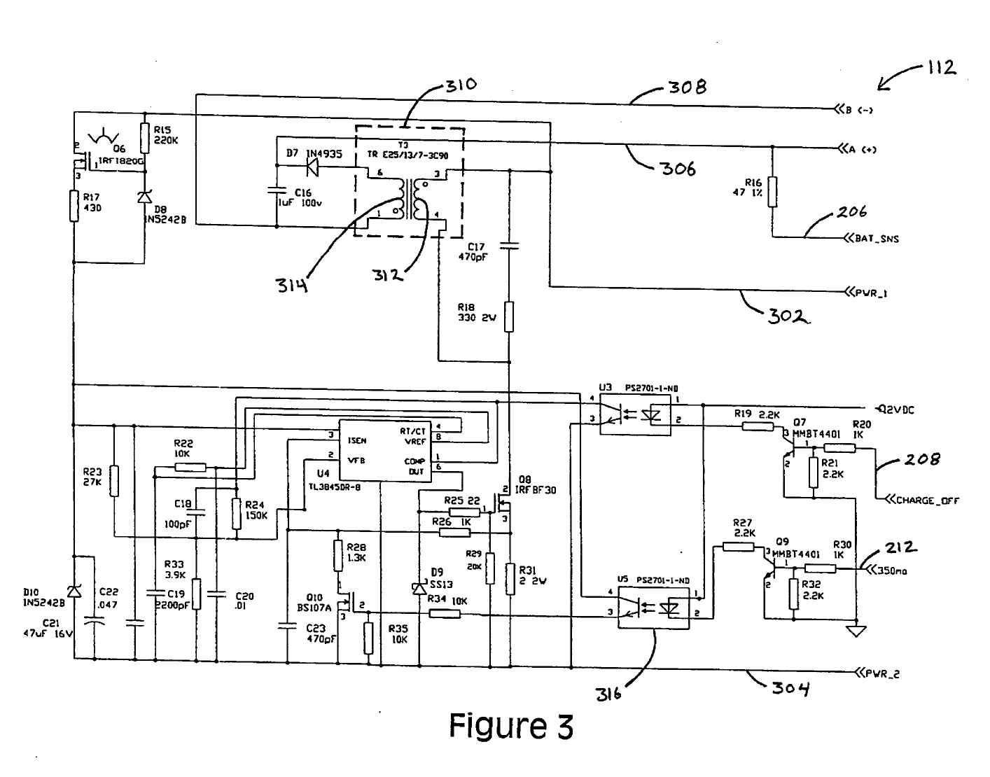

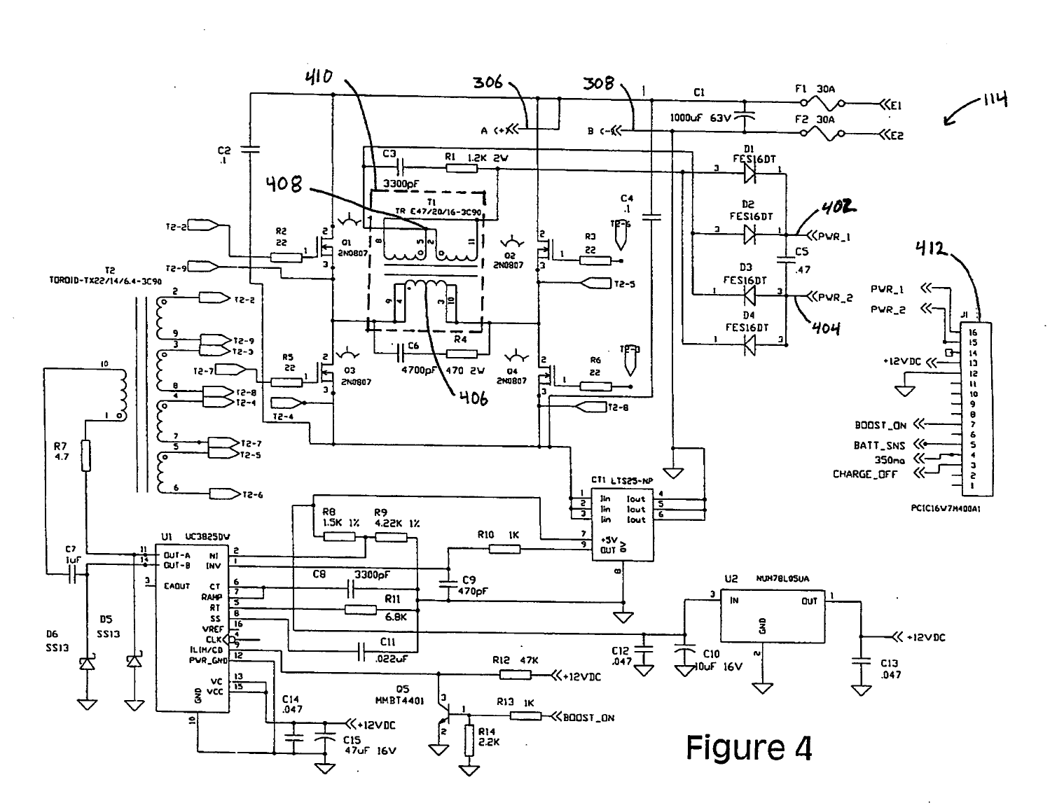

In the present embodiment, the boost converter 114 and the battery charger 112 are one functional block, however, the present embodiment further contemplates having two separate hot-swappable elements: the boost converter 114, further described in FIG. 4, and the battery charger 112, further described in FIG. 3.

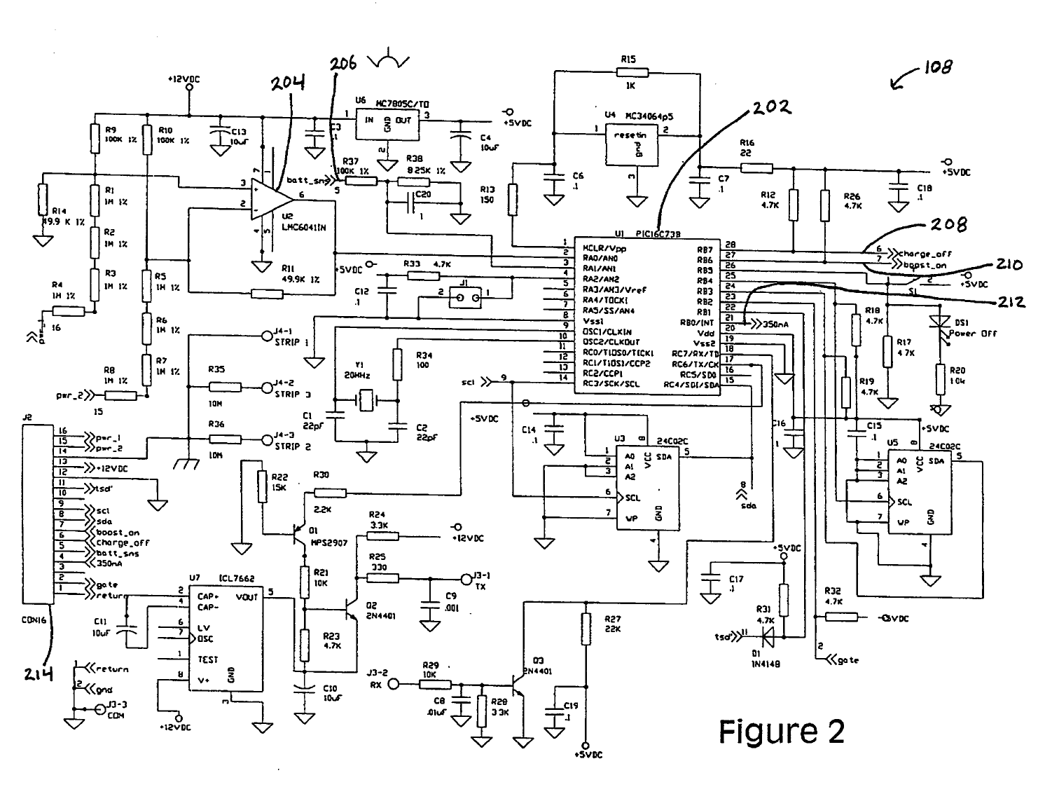

Referring next to FIG. 2, shown is a schematic diagram of the management module 108 shown in FIG. 1. Shown is a microprocessor 202, a operational amplifier 204, a battery sense line 206, a charge off line 208, a boost on line 210, a 350 mA line 212, and a management module pin connector 214. The microprocessor 202 is coupled to the operational amplifier 204 which is coupled to the AC input power line 102. The microprocessor 202 is also coupled to the battery 110 through the battery sense line 206.

The operational amplifier 204 detects when there has been a failure of the AC input power line 102 and sends a signal upon failure to the microprocessor 202. Upon a failure of the AC input power line 102, the microprocessor 202 sets the boost on line 210 to high, causing the computer system (or other equipment) to be powered by the battery 110. This provides the backup power to the computer system (or other equipment), e.g., during a power outage.

The AC input power line 102 supplies power to the computer system (or other equipment) and also provides power to charge the battery 110. The battery 110 is coupled to the AC input power line 102 through the battery charger 112. The battery's voltage is monitored through the battery sense line 206. When the battery 110 reaches a predetermined voltage the microprocessor 202 sets the charge off line 208 to high, causing the battery 110 to stop being charged. This ensures the battery 110 is capable of providing backup power if the AC input power line 102 fails. The battery charger 112 additionally has two charging states: a high charging state and a low charging state. Depending on the amount the battery 110 is charged the battery charger 112 will be set to the high charging state or the low charging state by the microprocessor 202. When the battery 110 is low the microprocessor 202 will set the battery charger 112 to the high charging state. When the battery 110 is nearing full charge the microprocessor 202 sets the battery charger 112 to the low charging state which prevents overcharging and damage to the battery 110.

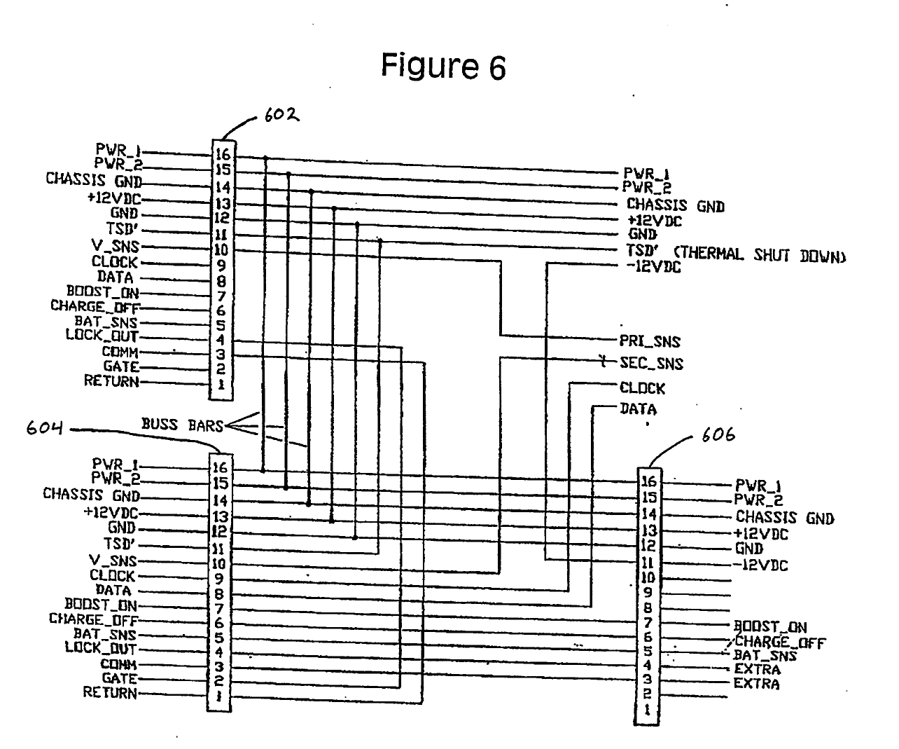

The management module pin connector 214 connects to the management module connector 604, shown in FIG. 6. This allows for easy removal of the management module 108 even when the system is being powered from the AC input power line 102. The management system is hot-swappable, thus can be removed, replaced, or upgraded without powering down the computer system.

Referring to FIG. 3, shown is a schematic diagram of the battery charger 112 shown in FIG. 1. Shown is a first power line 302, a second power line 304, a positive battery terminal 306, a negative battery terminal 308, a fly-back regulator 310, a primary winding 312, a secondary winding 314, an opto-coupler 316, the 350 mA line 212, the battery sense line 206, and the charge off line 208.

The first power line 302 and the second power line 304 are coupled to the primary winding 312 of the fly-back regulator 310. The positive battery terminal 306 and the negative battery terminal 308 are coupled to the secondary winding 314 of the fly-back regulator 310. The battery sense line 206 is coupled to the positive battery terminal 312 and is additionally coupled back to the microprocessor 202. The 350 mA line 212 is coupled to the primary winding 312 of the fly-back regulator 310 though the opto-coupler 316.

Current flows through the primary winding 312 of the fly-back regulator 310 causing an magnetic field to build up in the core of the fly-back regulator 310. When current stops flowing in the primary winding 312, the magnetic field collapses, inducing a current in the secondary winding 314 of the fly-back regulator 314. The current is run through the battery 110 to charge it.

The battery sense line 206 is an input into the microprocessor 202. If the battery 110 is fully charged the microprocessor 202 will set the charge off line 208 to high causing the battery charger 112 to stop charging the battery 110.

If the battery 110 is very depleted the 350 mA line 212 is set to high by the microprocessor 202 which allows a fast charging rate. As the battery 110 approaches being fully charged the 350 mA line 212 is set to low by the microprocessor 202 which allows the battery 110 to charge at a slower rate so as not to overcharge and damage the battery 110. Once the battery 110 is fully charged the microprocessor 202 sets the charge off line 208 to high which no longer allows the battery 110 to be charged.

Referring to FIG. 4, shown is a schematic diagram of the boost converter 114 shown in FIG. 1. Shown is a first backup power line 402, a second backup power line 404, the positive battery terminal 306, the negative battery terminal 308, a boost transformer 410, a primary transformer winding 406, a secondary transformer winding 408, a boost converter pin connector 412, and the boost on line 210.

The boost on line 210 is coupled to the microprocessor 202. The positive battery terminal 306 and the negative battery terminal 308 are coupled to a primary transformer winding 406 of the boost transformer 410. The first backup power line 402 and the second backup power line 404 are coupled to the secondary transformer winding 408 of the boost transformer 410.

When the operational amplifier 204, shown in FIG. 2, sends a signal to the microprocessor 202 that there has been a failure of the AC input power line 102, the microprocessor 202 sets the boost on line 210 to high. This turns on the boost converter 114. The battery 110 now is providing the power to the computer system. In one embodiment the battery output voltage is 48 volts. This is input into the primary transformer winding 412 of the boost transformer 410. The boost transformer 410 creates an output of 120 volts at the secondary transformer winding 414 of the boost transformer 410. The 120 volt output is the computer power input into the N+1 redundant secondary power supplies.

The boost converter pin connector 412 connects to the boost convertor connector 606, shown in FIG. 6, allowing for the easy removal, replacement, or upgrade of the boost converter 114 and the battery charger 112. The boost converter and the battery charger are both hot-swappable, thus can be removed, replaced, or upgraded without powering down the computer system. As shown in FIG. 1, the boost 114 converter and the battery charger 112 are one component, however, the present embodiment contemplates the battery charger 112 being a separate component from the boost converter and having its own pin connector.

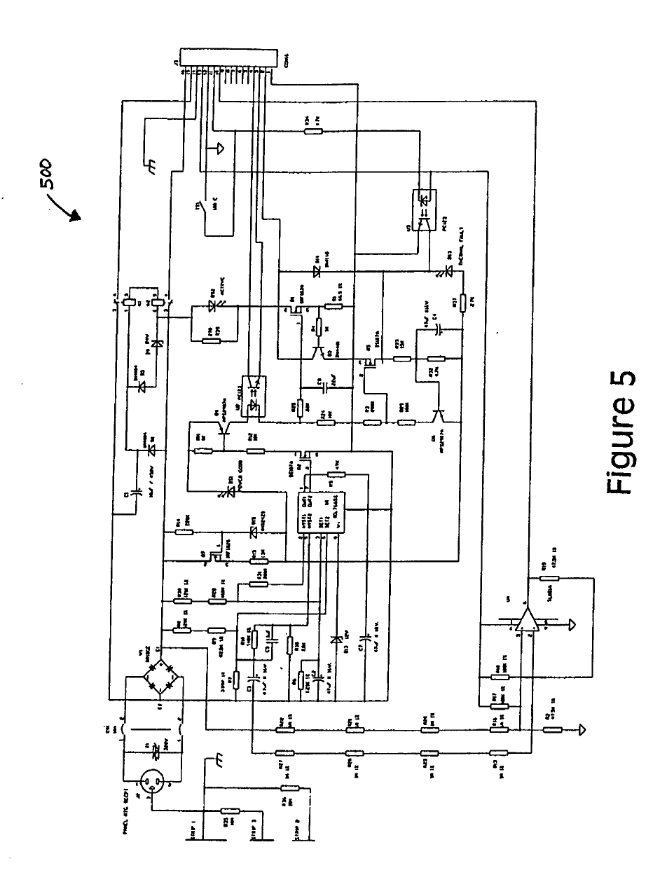

Referring to FIG. 5, shown is a schematic diagram of an input module 500. The input module 500 is used to electrically isolate the power supplies. Opto-couplers are used to isolate the two sources of power: the AC power line and the battery. The input module 500 is fully described in U.S. patent application Ser. No. 10/160,285, Attorney Docket Number 73511, fully incorporated herein by reference.

Referring to FIG. 6, shown is a backplane diagram of the embedded uninterruptible power supply 100 shown in FIG. 1. Shown is an AC module connector 602, a management module connector 604, and a boost converter connector 606.

The input module 500, shown in FIG. 5, plugs into the AC module connector 602. This supplies the main power to the computer system. The management module 108 plugs into the management module connector 604 and the boost converter 114 plugs into the boost converter connector 606. This allows for complete replacement, removal, or upgrade of the management module 108, the battery 110, the boost converter 114, and the battery charger 112 while the computer system (or other equipment) is still powered by the AC input power line 102. The connectors help facilitate the hot-swappable feature of the present embodiment, however, any method of removing and replacing the management module 108, the battery 110, the boost converter 114, and the battery charger 112 are contemplated in the present embodiment.

While the invention herein disclosed has been described by means of specific embodiments and applications thereof, numerous modifications and variations could be made thereto by those skilled in the art without departing from the scope of the invention set forth in the following claims.

What is claimed is:

1. An apparatus for powering a computer system comprising:
a power input line for providing power to the computer system;
a hot-swappable management module coupled to the power input line which monitors the power input line for a failure; and
a hot-swappable battery coupled to the power input line and the hot-swappable management module which provides power to the computer system upon the failure of the power input line.

2. The apparatus of claim 1 further comprising a boost converter coupled to the battery which changes the voltage input to the computer system.

3. The apparatus of claim 2 wherein the boost converter is hot-swappable.

4. The apparatus of claim 1 further comprising a battery charger coupled to the power input line for charging the battery when the power input line is providing the power to the computer system.

5. The apparatus of claim 1 further comprising a microprocessor within the hot-swappable management module which controls the power to the computer system.

6. The apparatus of claim 1 wherein the hot-swappable management module comprises:
a microprocessor for sending control signals; and
a operational amplifier for determining when a failure of the power input line has occurred.

7. A method of powering a computer system comprising:
powering the computer system from a power input line;
monitoring the power input line with a management module for a failure of the power input line;
powering the computer system from a battery in the event of the failure of the power input line; and
replacing the battery and the management module without interrupting the powering of the computer system from the power input line.

8. The method of claim 7 further comprising:
modifying the voltage from the battery before powering the computer system.

9. The method of claim 7 further comprising:
increasing the voltage from the battery from 48 volts to 120 volts.

10. The method of claim 7 further comprising:
charging the battery with a battery charger while powering the computer system from the power input line.

11. The method of claim 10 further comprising coupling the battery charger to the power input line.

12. The method of claim 10 further comprising replacing the battery charger without interrupting the powering of the computer system from the power input line.

13. A method of powering a computer system comprising:
supplying the computer system with power from a power line;
monitoring the power line for a failure with an operational amplifier;
receiving a failure signal at a microprocessor upon detection of the failure from the operational amplifier;
sending a switching signal from the microprocessor in response to the receiving of the failure signal;
supplying the computer system with power from a hot-swappable battery in response to the sending of the switching signal from the microprocessor.

14. The method of claim 13 further comprising charging the hot-swappable battery with a battery charger while supplying the computer system with power from the power line.

15. The method of claim 13 further comprising:
coupling the hot-swappable battery to the power line through a transformer; and
charging the hot-swappable battery while supplying the computer system with power from the power line.

16. The method of claim 13 further comprising coupling the output voltage of the battery to the power line through a transformer.

17. A method of powering a computer system comprising:
powering the computer system from a power line;
monitoring the power line with a first management module for a failure of the power line;
replacing the first management module and the first battery with a second management module and a second battery while the computer system is powered on;
monitoring the power line with the second management module for the failure of the power line; and
powering the computer system with the second battery in the event of a detection of the failure of the power line by the second management module.

18. The method of claim 17 further comprising coupling the battery to the power line through a transformer.

19. The method of claim 18 further comprising charging the battery while powering the computer system from the power line.

20. The method of claim 17 further comprising coupling the output voltage of the battery to the power line through a transformer.
